(19) United States
(12) Patent Application Publication
(10) Pub. No.: US 2011/0102828 A1
(43) Pub. Date: May 5, 2011

(54) IMAGE FORMING SYSTEM

(75) Inventors: Toshihiro Ida, Shizuoka-ken (JP); Kazuhiro Ogura, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/914,162

(22) Filed: Oct. 28, 2010

Related U.S. Application Data
(60) Provisional application No. 61/256,511, filed on Oct. 30, 2009.

(51) Int. Cl. G06F 3/12

(52) U.S. Cl. 358/1.13

(57) ABSTRACT

According to one embodiment, an image forming system includes a printing unit and a copying unit. The printing unit selects, during printing on a recording medium, whether printing information or a background is rendered with first dots having a size set in advance or rendered with second dots larger than the first dots and prints the printing information or the background. The copying unit selects, during copying of the recording medium on which the printing information or the background is rendered by the printing unit, whether the first dots rendered on the recording medium are erased or density of the second dots is increased.

### CROSS-REFERENCE TO RELATED APPLICATIONS

This application is based upon and claims the benefit of priority from: U.S. provisional application 61/256,511, filed on Oct. 30, 2009, the entire contents of each of which are incorporated herein by reference.

### FIELD

Embodiments described herein relate generally to, for example, an image forming system including a function of suppressing illegal copying in order to prevent leakage of information.

### BACKGROUND

For example, there is a technique for suppressing illegal copying in order to prevent leakage of information. In the technique for suppressing illegal copying, woven pattern printing, a watermark, or the like is used. In this suppressing technique, when an original is copied, for example, characters appear on a copied sheet. This suppressing technique has an effect of indicating that the copied sheet is not the original and suppressing copying of the original by using the woven pattern printing, the watermark, or the like.

### BRIEF DESCRIPTION OF THE DRAWINGS

FIG. 1 is a diagram of an image forming system according to a first embodiment;

FIG. 2 is a diagram of a PC for printing;

FIG. 3 is a functional block diagram of the PC for printing;

FIG. 4 is a diagram of a printing request screen;

FIG. 5A is a diagram of a first mode pattern of a print request;

FIG. 5B is a diagram of a second mode pattern of the print request;

FIG. 5C is a diagram of a third mode pattern of the print request;

FIG. 5D is a diagram of a fourth mode pattern of the print request;

FIG. 5E is a diagram of a fifth mode pattern of the print request;

FIG. 6 is a diagram of an example of a secret information designation screen;

FIG. 7 is a diagram of a MFP;

FIG. 8 is a functional block diagram of the MFP;

FIG. 9 is a woven pattern printing flowchart; and

FIG. 10 is a woven pattern copying flowchart.

### DETAILED DESCRIPTION

In general, according to one embodiment, an image forming system includes a printing unit and a copying unit. The printing unit selects, during printing on a recording medium, whether printing information or a background is rendered with first dots having a size set in advance or rendered with second dots larger than the first dots and prints the printing information or the background. The copying unit selects, during copying of the recording medium on which the printing information or the background is rendered, whether the first dots rendered on the recording medium are erased or density of the second dots is increased.

An embodiment is explained below with reference to the drawings.

FIG. 1 is a diagram of an image forming system. The image forming system includes a digital multifunction peripheral (hereinafter referred to as MFP) 1 and a personal computer for printing (hereinafter referred to as PC for printing) 2. An operation unit 4 and a display 5 are connected to the PC for printing 2. The operation unit 4 is, for example, a keyboard or a mouse. The display 5 is, for example, a liquid crystal display. In the PC for printing 2, an image IM of image data for woven pattern printing formed on the PC 2 is schematically shown.

The MFP 1 performs, for example, printing of a document on a recording medium 3, copying of the recording medium 3 having the document recorded thereon, and printing of image data or the like transmitted from the outside on the recording medium 3. The MFP 1 includes a function of determining whether woven pattern printing is performed and, if the woven pattern printing is performed, applying the woven pattern printing to the recording medium 3. The MFP 1 includes a function of determining whether the recording medium 3 is subjected to the woven pattern printing and, if the recording medium 3 is subjected to the woven pattern printing, performing copying of the recording medium 3 corresponding to the woven pattern printing.

In the woven pattern printing, in general, for example, a portion that disappears during copying is rendered on the recording medium 3 with first dots having a small diameter (small dots) and hidden characters are rendered on the recording medium 3 with second dots having a large diameter (large dots). The diameter of the large dots is set larger than the diameter of the small dots. During copying, the large dots are targets of replacement with a darker color. During copying, the small dots are targets of erasing. Determination concerning whether the woven pattern printing is performed is determination for recognizing, on the basis of a certain threshold, the large dots as the targets of replacement with a darker color and the small dots as the targets of erasing.

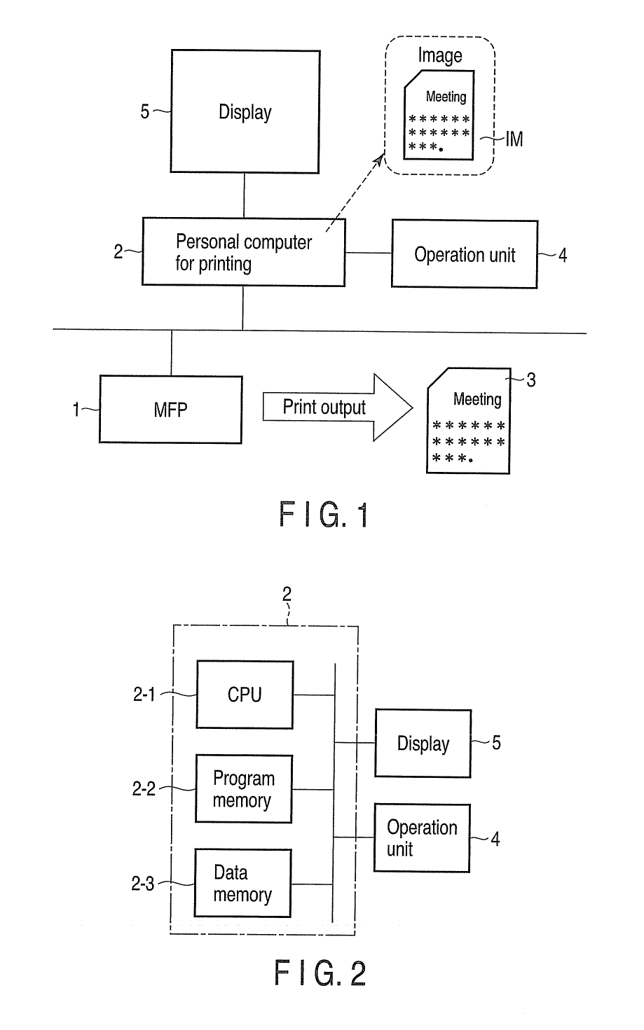

FIG. 2 is a diagram of the PC for printing 2. The PC for printing 2 generates a job for performing the woven pattern printing in the MFP 1. The PC for printing 2 is mounted with a CPU 2-1. A program memory 2-2, a data memory 2-3, the operation unit 4, and the display 5 are connected to the CPU 2-1. An image forming program readable by the CPU 2-1 is stored in the program memory 2-2. The image forming program selects, during printing on the recording medium 3, whether printing information or a background is rendered with small dots having size set in advance or with large dots larger than the small dots. The printing information includes, for example, characters or a pattern to be rendered on the recording medium 3. A background color includes information concerning a color as the background of the printing information.

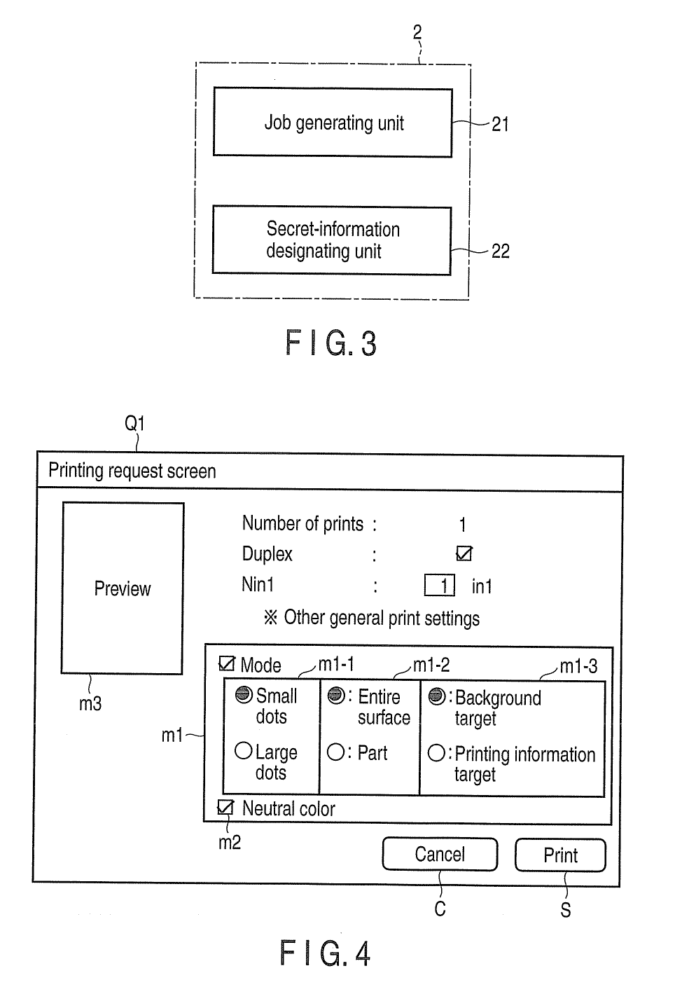

FIG. 3 is a functional block diagram of the PC for printing 2. The PC for printing 2 includes a job generating unit 21 and a secret-information designating unit 22. The job generating unit 21 displays a printing request screen Q1 shown in FIG. 4 on the display 5, receives operation on the operation unit 4 by a user, and generates a job for performing the woven pattern printing in the MFP 1. The job is a request for subjecting various kinds of image data to the woven pattern printing. The various kinds of image data include the background color and the printing information.

The printing request screen Q1 includes a mode pattern selection column m1 for setting a mode of the woven pattern printing besides setting the number of prints. The mode pattern selection column m1 includes a dot selection column m1-1, an entire surface or part selection column m1-2, and a target selection column m1-3. The dot selection column m1-1 is a column for selecting the small dots or the large dots. The entire surface or part selection column m1-2 is a column for selecting to which of the entire surface and a part of the recording medium 3 the small dots or the large dots selected in the dot selection column m1-1 are applied. The target selection column m1-3 is a column for selecting to which of the background and the printing information the small dots or the large dots selected in the dot selection column m1-1 are applied.

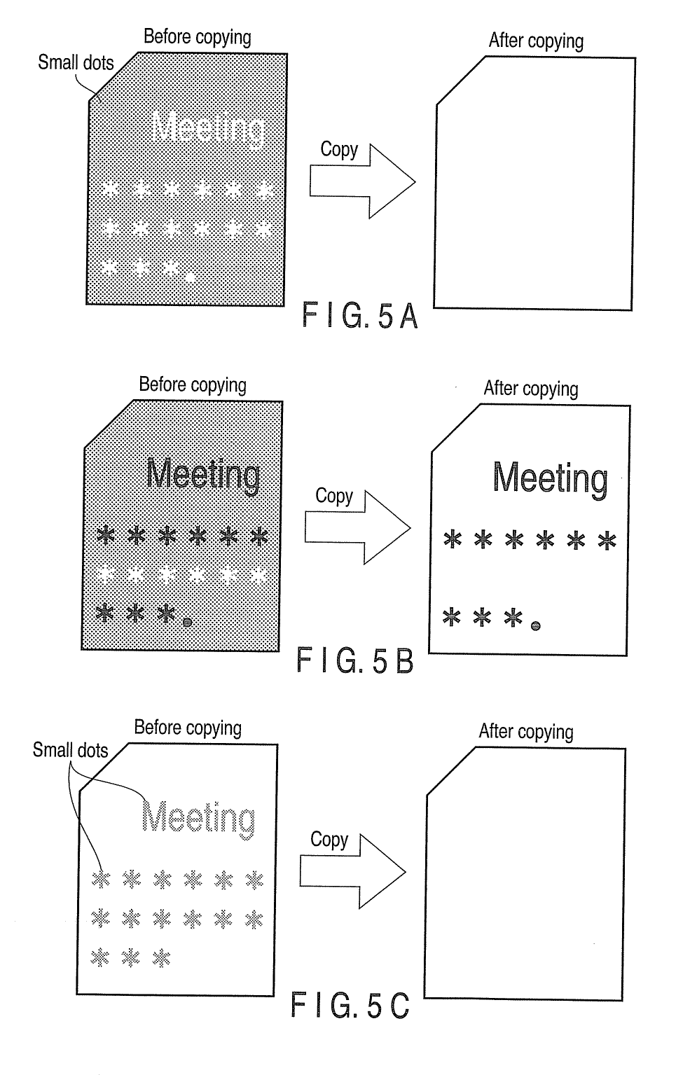

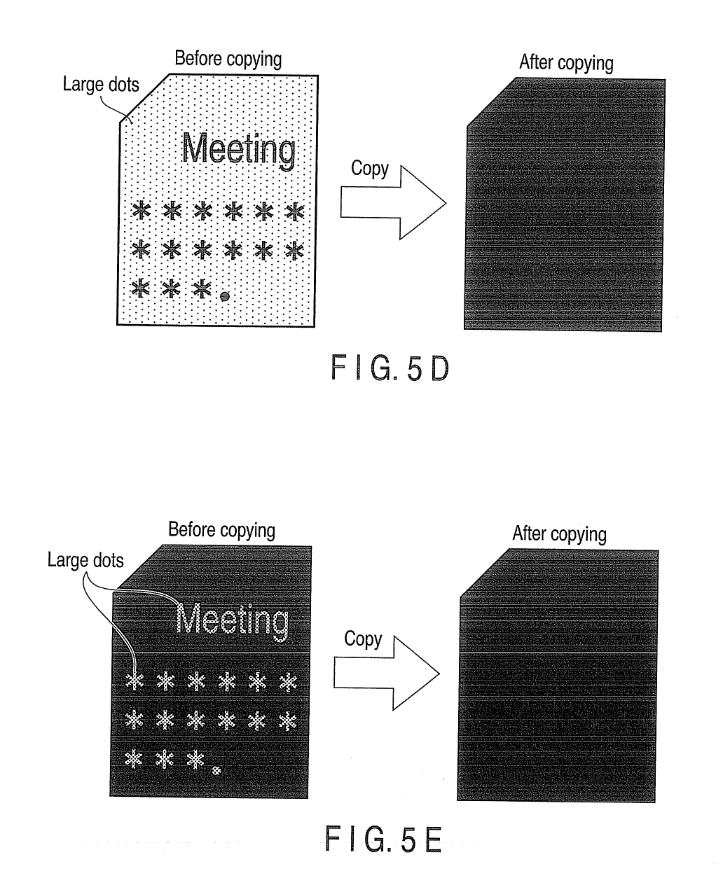

Examples of mode patterns are explained with reference to FIGS. 5A to 5E.

FIG. 5A is a diagram of a first mode pattern. In the first mode pattern, the small dots, the entire surface, and the background are selected. In the first mode pattern, during copying, the small dots to be erased by the MFP1 are embedded in the background and the printing information is set to a color same as the background color. If secret information is formed by the background, the small dots on the background are erased during copying and the secret information disappears from the recording medium 3.

FIG. 5B is a diagram of a second mode pattern. In the second mode pattern, the small dots, a part, and the background are selected. In the second mode pattern, only a place desired to be erased during copying is set to the background color by the user in advance. The setting of only the place desired to be erased to the background color is performed by using, for example, an electronic file browsing application mounted on the PC for printing 2. The electronic file browsing application is executed by the secret-information designating unit 22. During copying, secret information of a place designated by the secret-information designating unit 22 disappears from the recording medium 3.

FIG. 5C is a diagram of a third mode pattern. In the third mode pattern, the small dots, the entire surface, and the printing information are selected. In the third mode pattern, the printing information is rendered with the small dots. During copying, secret information of the small dots rendered on the recording medium 3 disappears from the recording medium 3 according to the erasing of the small dots.

FIG. 5D is a diagram of a fourth mode pattern. In the fourth mode pattern, the large dots, the entire surface, and the background are selected. In the fourth mode pattern, during copying, the large dots not to be erased are rendered on the background. During copying, secret information on the recording medium 3 is hidden by high density of the background because the density of the large dots on the background increases.

FIG. 5E is a diagram of a fifth mode pattern. In the fifth mode pattern, the large dots, the entire surface, and the printing information are selected. In the fifth mode pattern, the printing information is rendered with the large dots and the background is rendered with the large dots in a color set to be darker after copying. During copying, since the density of the large dots increases, secret information on the recording medium 3 has density same as the density of the background and is hidden by the background.

The printing request screen Q1 includes a check column m2 for selecting whether the large dots or the small dots correspond to a neutral color. When the large dots or the small dots correspond to the neutral color, the job generating unit 21 generates a job for rendering portions other than a plain portion with the large dots. For example, if the printing information is, for example, gray, the job generating unit 21 binarizes the printing information of the neutral color into “0” and “1”. As a result of the binarization, if the background color is set to “0”, the job generating unit 21 generates a command for regarding a portion of “1” other than “0” as a target for embedding dots.

The printing request screen Q1 includes a preview screen m3. The preview screen m3 displays a printing preview corresponding to a mode pattern selected in the mode pattern selection column m1.

The printing request screen Q1 includes a printing button S and a cancel button C. If the printing button S is operated by the user, the PC for printing 2 starts print processing with the job generating unit 21.

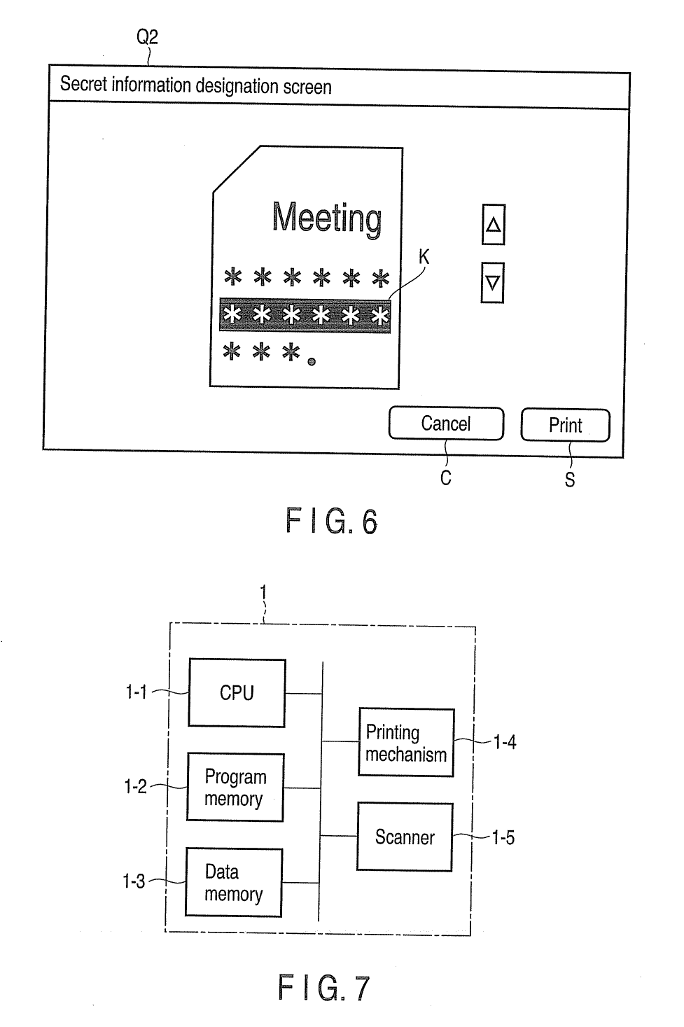

The secret-information designating unit 22 sets only a place desired to be erased during copying to the background color in advance. FIG. 6 is a diagram of an example of a secret information designation screen Q2. In the secret information designation screen Q2, for example, only a place K of secret information desired to be erased during copying is set to the background color by operation on the operation unit 4 by the user, for example, operation of the mouse. For example, in the second mode pattern shown in FIG. 5B, only the place K of the secret information desired to be erased during copying is set to the background color in advance. The user sets the place K of the secret information desired to be erased during copying by performing drag and move operation using the mouse. For example, the user performs release of the setting of the place K of the secret information by clicking the place K of the setting of the secret information using the mouse. The secret information designation screen Q2 includes the printing button S and the cancel button C. If the printing button S is operated by the user, the PC for printing 2 starts print processing with the job generating unit 21.

FIG. 7 is a diagram of the MFP 1. The MFP 1 receives a job generated by the PC for printing 2 and performs the woven pattern printing and performs copying of the recording medium 3 on which a woven pattern is printed. The MFP 1 is mounted with a CPU 1-1. A program memory 1-2, a data memory 1-3, a printing function 1-4, and a scanner 1-5 are connected to the CPU 1-1.

An image forming program readable by the CPU 1-1 is stored in the program memory 1-2. The image forming program renders printing information or a background on the recording medium 3 with the small dots or renders the printing information or the background on the recording medium 3 with the large dots. During copying of the recording medium 3, the image forming program selects, on the basis of a predetermined threshold, whether the small dots rendered on the recording medium 3 are erased or the density of the large dots is increased and erases the small dots rendered on the recording medium 3 or increases the density of the large dots rendered on the recording medium 3.

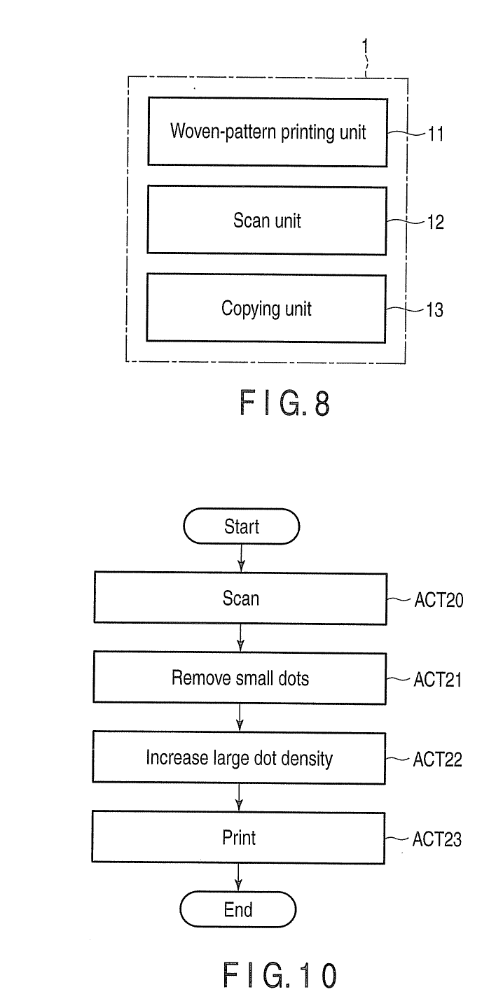

FIG. 8 is a functional block diagram of the MFP 1. The MFP 1 includes a woven-pattern printing unit 11, a scan unit 12, and a copying unit 13. The woven-pattern printing unit 11 receives a job generated by the PC for printing 2 and renders printing information or a background on the recording medium 3 with the small dots or renders the printing information or the background on the recording medium 3 with the large dots.

The woven-pattern printing unit 11 performs rendering on the recording medium 3 according to the first to fifth mode patterns (FIGS. 5A to 5E) corresponding to a print request by the job generated by the PC for printing 2.

In the first mode pattern shown in FIG. 5A, the woven-pattern printing unit 11 sends a command for rendering the entire background on the recording medium 3 with the small dots to the printing mechanism 1-4.

In the second mode pattern shown in FIG. 5B, the woven-pattern printing unit 11 sends a command for rendering a part of the background on the recording medium 3 with the small dots to the printing mechanism 1-4. A part of the background to be rendered with the small dots is selected by operation by the user on the secret information designation screen Q2 shown in FIG. 6.

In the third mode pattern shown in FIG. 5C, the woven-pattern printing unit 11 sends a command for rendering the entire printing information on the recording medium 3 with the small dots to the printing mechanism 1-4.

In the fourth mode pattern shown in FIG. 5D, the woven-pattern printing unit 11 sends a command for rendering the entire background on the recording medium 3 with the large dots to the printing mechanism 1-4.

In the fifth mode pattern shown in FIG. 5E, the woven-pattern printing unit 11 sends a command for rendering the entire printing information on the recording medium 3 with the large dots to the printing mechanism 1-4.

During copying, the scan unit 12 scans the recording medium 3 on which a woven pattern is printed and acquires a scan image.

A printing unit including the job generating unit 21 and the secret-information designating unit 22 of the PC for printing 2 and the woven-pattern printing unit 11 of the MFP 1 is built.

The copying unit 13 receives the scan image acquired by the scan unit 12, selects, according to the first to fifth mode patterns (FIGS. 5A to 5E), on the basis of the predetermined threshold, whether the small dots rendered on the recording medium 3 are erased or the density of the large dots is increased, and erases the small dots or increases the density of the large dots and performs rendering on the recording medium 3.

In the first mode pattern shown in FIG. 5A, the copying unit 13 sends image data in which the small dots rendered on the entire surface of the recording medium 3 are erased to the printing mechanism 1-4.

In the second mode pattern shown in FIG. 5B, the copying unit 13 sends image data in which the small dots rendered on a part of the printing information are erased to the printing mechanism 1-4.

In the third mode pattern shown in FIG. 5C, the copying unit 13 sends image data in which the small dots rendered on a portion corresponding to the printing information are erased to the printing mechanism 1-4.

In the fourth mode pattern shown in FIG. 5D, the copying unit 13 sends image data in which the density of the large dots rendered on the entire surface of the recording medium 3 is increased to the printing mechanism 1-4.

In the fifth mode pattern shown in FIG. 5E, the copying unit 13 sends image data in which the density of the large dots, with which the printing information is rendered, is increased to the printing mechanism 1-4.

The printing mechanism 1-4 generates image data conforming to any one mode pattern among the first to fifth mode patterns from the woven-pattern printing unit 11 or the copying unit 13 and performs printing on the recording medium 3.

A woven-pattern printing operation of the system configured as explained above is explained below according to a woven-pattern printing flow chart of FIG. 9.

The job generating unit 21 of the PC for printing 2 displays the printing request screen Q1 shown in FIG. 4 on the display 5. On the printing request screen Q1, the user selects the small dots or the large dots, selects to which of the entire surface and a part of the recording medium 3 the selected small dots or large dots are applied, selects to which of the background and the printing information the selected small dots or the large dots are applied, and selects whether the large dots or the small dots correspond to the neutral color.

The job generating unit 21 generates a job for performing the woven pattern printing including the information selected on the printing request screen Q1. Specifically, if the printing button S on the printing-request screen Q1 is operated by the user, the job generating unit 21 starts print processing (ACT 1).

The job generating unit 21 determines whether the large dots or the small dots correspond to the neutral color from the check column m2 for the neutral color on the printing request screen Q1 (ACT 2). On the printing request screen Q1 shown in FIG. 4, it is checked whether the large dots or the small dots correspond to the neutral color. As a result of the determination, if the large dots or the small dots correspond to the neutral color, the job generating unit 21 binarizes the printing information of the neutral color into “0” and “1”. As a result of the binarization, if the background color is set to “0”, the job generating unit 21 regards a portion of “1” other than “0” as a target for embedding dots (ACT 3).

The job generating unit 21 determines, from the dot selection column m1-1 on the printing request screen Q1, whether a dot target to be the small dots or the large dots in the woven pattern printing is the background or the printing information (ACT 4). In the printing request screen Q1 shown in FIG. 4, selection concerning whether the dot target is the background or the printing information is performed.

As a result of the determination, if the background is selected as the dot target, the job generating unit 21 acquires the background color (ACT 5).

The job generating unit 21 determines, from the target selection column m1-3 on the printing request screen Q1, to which of the entire surface and a part of the recording medium 3 the small dots or the large dots to be subjected to the woven pattern printing are applied (ACT 6). As a result of the determination, if the large dots or the small dots are applied to the entire surface of the recording medium 3, the job generating unit 21 acquires rendering positions of the small dots or the large dots on the entire surface of the recording medium 3 (ACT 7).

If the large dots or the small dots are applied to a part of the recording medium 3, the job generating unit 21 acquires rendering positions of the small dots or the large dots from the secret-information designating unit 22 (ACT 8). The secret-information designating unit 22 sets in advance the background color only in the place K desired to be erased during copying on the secret information designation screen Q2 shown in FIG. 6. The user sets the place K of the secret information desired to be erased during copying by performing drag and move operation using the mouse.

The job generating unit 21 determines, from the dot selection column m1-1 on the printing request screen Q1, the width of the dots, i.e., which of the small dots and the large dots are selected (ACT 9). As a result of the determination, if the small dots are selected, the job generating unit 21 creates rendering information with the small dots (ACT 10). If the large dots are selected, the job generating unit 21 creates rendering information with the large dots (ACT 11).

The job generating unit 21 transmits, to the MFP 1, a job for performing the woven pattern printing including the information selected on the printing request screen Q1, i.e., the information concerning which of the small dots and the large dots are selected, to which of the entire surface and a part of the recoding medium 3 the small dots or the large dots are applied, to which of the background and the printing information the small dots or the large dots are applied, and whether the large dots or the small dots correspond to the neutral color.

The woven-pattern printing unit 11 of the MFP 11 performs rendering on the recording medium 3 according to the first to fifth mode patterns (FIGS. 5A to 5E) corresponding to a printing request by the job generated by the PC for printing 2.

In the first mode pattern shown in FIG. 5A, the woven-pattern printing unit 11 sends a command for rendering the entire background on the recording medium 3 with the small dots to the printing mechanism 1-4. The printing mechanism 1-4 prints the entire background on the recording medium 3 with the small dots.

In the second mode pattern shown in FIG. 5B, the woven-pattern printing unit 11 sends a command for rendering a part of the background on the recording medium 3 with the small dots as shown in FIG. 6 to the printing mechanism 1-4. The printing mechanism 1-4 prints a part of the background on the recording medium 3 with the small dots.

In the third mode pattern shown in FIG. 5C, the woven-pattern printing unit 11 sends a command for rendering the entire printing information on the recording medium 3 with the small dots to the printing mechanism 1-4. The printing mechanism 1-4 prints the entire printing information on the recording medium 3 with the small dots.

In the fourth mode pattern shown in FIG. 5D, the woven-pattern printing unit 11 sends a command for rendering the entire background on the recording medium 3 with the large dots to the printing mechanism 1-4. The printing mechanism 1-4 prints the entire background on the recording medium 3 with the large dots.

In the fifth mode pattern shown in FIG. 5E, the woven-pattern printing unit 11 sends a command for rendering the entire printing information on the recording medium 3 with the large dots to the printing mechanism 1-4. The printing mechanism 1-4 prints the entire printing information on the recording medium 3 with the large dots.

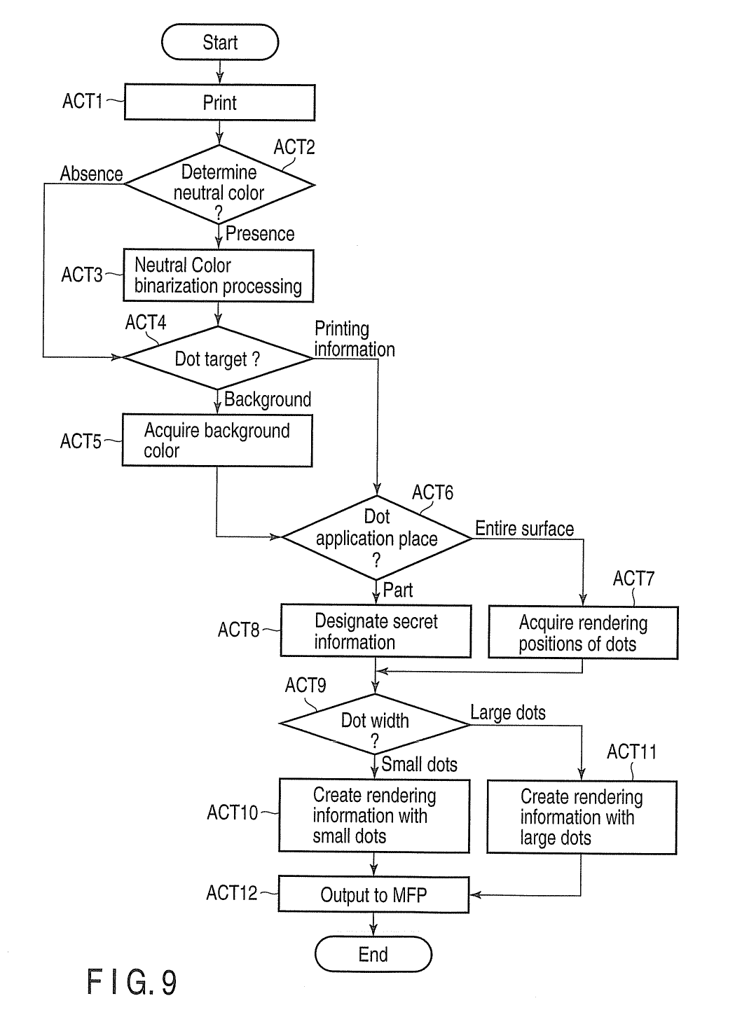

A woven-pattern copying operation by the system configured as explained above is explained below according to a woven-pattern copying flowchart of FIG. 10.

The scan unit 12 scans, during copying, the recording medium 3 on which a woven pattern is printed and acquires a scan image (ACT 20).

The copying unit 13 receives the scan image acquired by the scan unit 12, determines the small dots rendered on the recording medium 3 according to the first to fifth mode patterns (FIGS. 5A to 5E), and erases the small dots (ACT 21).

The copying unit 13 receives the scan image acquired by the scan unit 12, determines the large dots rendered on the recording medium 3 according to the first to fifth mode patterns (FIGS. 5A to 5E), increases the density of the large dots (ACT 22), and performs printing on the recording medium 3 (ACT 23).

In the first mode pattern shown in FIG. 5A, the copying unit 13 sends image data in which the small dots rendered on the entire surface of the recording medium 3 are erased to the printing mechanism 1-4. The printing mechanism 1-4 erases the small dots rendered on the entire surface of the recording medium 3 on the basis of the image data and performs printing. As a result, secret information rendered plain on the recording medium 3 disappears from the recording medium 3 according to the erasing of the small dots of the background.

In the second mode pattern shown in FIG. 5B, the copying unit 13 sends image data in which the small dots rendered on a part of the printing information are erased to the printing mechanism 1-4. The printing mechanism 1-4 erases the small dots rendered on a part of the printing information on the basis of the image data and performs printing. As a result, the secret information rendered plain on the recording medium 3 disappears from the recording medium 3 according to the erasing of the small dots.

In the third mode pattern shown in FIG. 5C, the copying unit 13 sends image data in which the small dots rendered on a portion corresponding to the printing information are erased to the printing mechanism 1-4. The printing mechanism 1-4 erases the small dots rendered on the portion corresponding to the printing information on the basis of the image data and performs printing. As a result, the secret information rendered on the recording medium 3 with the small dots disappears from the recording medium 3 according to the erasing of the small dots.

In the fourth mode pattern shown in FIG. 5D, the copying unit 13 sends image data obtained by increasing the density of the large dots rendered on the entire surface of the recording medium 3 to the printing mechanism 1-4. The printing mechanism 1-4 increases the density of the large dots rendered on the entire surface of the recording medium 3 on the basis of the image data and performs printing. As a result, the secret information on the recording medium 3 is hidden by the high density of the background because the density of the large dots on the background increases.

In the fifth mode pattern shown in FIG. 5E, the copying unit 13 sends image data in which the density of the large dots, with which the printing information is rendered, is increased to the printing mechanism 1-4. The printing mechanism 1-4 increases the density of the large dots, with which the printing information is rendered, on the basis of the image data and performs printing. As a result, the secret information on the recording medium 3 has density same as the density of the background and is hidden by the background because the density of the large dot increases.

As explained above, according to the embodiment, during printing on the recording medium 3, it is selected whether the printing information or the background is rendered with the small dots having the size set in advance or the large dots larger than the small dots. During copying of the recording medium 3, it is selected on the basis of the predetermined threshold whether the small dots rendered on the recording medium 3 are erased or the density of the large dots is increased. The small dots rendered on the recording medium 3 are erased or the density of the large dots rendered on the recording medium 3 is increased.

For example, in all the first to third mode patterns shown in FIGS. 5A to 5C, the secret information rendered with the small dots can be erased during copying. In both the fourth and fifth mode patterns shown in FIGS. 5D and 5E, the density of the secret information rendered with the large dots can be increased during copying and the secret information can be completely hidden. Therefore, it is possible to suppress illegal copying in order to prevent leakage of the secret information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming system comprising:
a printing unit configured to select, during printing on a recording medium, whether a printing information or a background is rendered with first dots having a size set in advance or rendered with second dots larger than the first dots and print the printing information or the background; and
a copying unit configured to select, during copying of the recording medium on which the printing information or the background is rendered by the printing unit, whether the first dots rendered on the recording medium are erased or density of the second dots is increased.

2. The system according to claim 1, wherein
the printing unit renders, during printing on the recording medium, the printing information or the background with the first dots, and
the copying unit erases, during copying of the recording medium on which the printing information or the background is rendered by the printing unit, the first dots rendered on the recording medium.

3. The system according to claim 1, wherein
the printing unit renders, during printing on the recording medium, the printing information or the background with the second dots, and
the copying unit increases, during copying of the recording medium on which the printing information or the background is rendered by the printing unit, the density of the second dots rendered on the recording medium.

4. The system according to claim 2, wherein
the printing unit renders an entire surface of the recording medium to be the background with the first dots and renders a portion corresponding to the printing information plain, and
the copying unit erases the first dots rendered on the entire surface of the recording medium.

5. The system according to claim 2, wherein
the printing unit renders a part of the printing information with the first dots, and
the copying unit erases the first dots rendered on the part of the printing information.

6. The system according to claim 2, wherein
the printing unit renders an entire surface of the recording medium to be the background plain and renders a portion corresponding to the printing information with the first dots, and
the copying unit erases the first dots rendered on the portion corresponding to the printing information.

7. The system according to claim 3, wherein
the printing unit renders an entire surface of the recording medium to be the background with the second dots and renders the printing information in a color same as a color of the second dots, and
the copying unit increases the density of the second dots rendered on the entire surface of the recording medium.

8. The system according to claim 3, wherein
the printing unit renders the printing information with the second dots and renders an entire surface of the recording medium to be the background in a color same as a color of the second dots, and
the copying unit increases the density of the second dots with which the printing information is rendered.

9. The system according to claim 1, wherein
the printing unit renders portions other than a plain portion with the second dots if the printing information includes a neutral color.

10. The system according to claim 1, wherein
the copying unit selects on the basis of a predetermined threshold whether the first dots rendered on the recording medium are erased or the density of the second dots is increased.

11. An image forming method comprising:
selecting, during printing on a recording medium, whether printing information or a background is rendered with first dots having a size set in advance or rendered with second dots larger than the first dots and printing the printing information or the background; and
selecting, during copying of the recording medium on which the printing information or the background is rendered, whether the first dots rendered on the recording medium are erased or density of the second dots is increased.

12. The method according to claim 11, further comprising:
rendering, during printing on the recording medium, the printing information or the background with the first dots; and
erasing, during copying of the recording medium on which the printing information or the background is rendered, the first dots rendered on the recording medium.

13. The method according to claim 11, further comprising:
rendering, during printing on the recording medium, the printing information or the background with the second dots; and
increasing, during copying of the recording medium on which the printing information or the background is rendered, the density of the second dots rendered on the recording medium.

14. The method according to claim 12, further comprising:
rendering an entire surface of the recording medium to be the background with the first dots and rendering a portion corresponding to the printing information plain; and
erasing the first dots rendered on the entire surface of the recording medium.

15. The method according to claim 12, further comprising:
rendering a part of the printing information with the first dots, and
erasing the first dots rendered on the part of the printing information.

16. The method according to claim 12, further comprising:
rendering an entire surface of the recording medium to be the background plain and rendering a portion corresponding to the printing information with the first dots; and
erasing the first dots rendered on the portion corresponding to the printing information.

17. The method according to claim 13, further comprising:
rendering an entire surface of the recording medium to be the background with the second dots and rendering the printing information in a color same as a color of the second dots; and
increasing the density of the second dots rendered on the entire surface of the recording medium.

18. The method according to claim 13, further comprising:
rendering the printing information with the second dots and rendering an entire surface of the recording medium to be the background in a color same as a color of the second dots; and
increasing the density of the second dots with which the printing information is rendered.

19. The method according to claim 11, further comprising
selecting on the basis of a predetermined threshold whether the first dots rendered on the recording medium are erased or the density of the second dots is increased.

20. A recording medium having stored thereon an image forming program readable by a computer, the image forming program causing the computer to execute:
selecting, during printing on a recording medium, whether printing information or a background is rendered with first dots having a size set in advance or rendered with second dots larger than the first dots and printing the printing information or the background; and
rendering the printing information or the background with the first dots or rendering the printing information or the background with the second dots.
